(19) United States
(12) Patent Application Publication
(10) Pub. No.: US 2026/0172740 A1
(43) Pub. Date: Jun. 18, 2026

(54) SYSTEM AND METHOD FOR DRIVING A TRANSDUCER

(71) Applicant: SONICEDGE LTD., Shoham (IL)

(72) Inventors: Sagi Chen, Haifa (IL); Ari Mizrachi, Shoham (IL); Mordehai Margalit, Zichron Yaaqov (IL)

(21) Appl. No.: 18/985,833

(22) Filed: Dec. 18, 2024

(51) Int. Cl. H04R 1/10

(52) U.S. Cl. CPC H04R 1/1083; H04R 1/1016; H04R 1/1025; H04R 1/1075; H04R 2201/003; H04R 2420/07; H04R 2460/11

(57) ABSTRACT

Techniques described herein generally relate to generating an audio signal with a speaker. In some examples, a speaker device is described that includes a membrane and a shutter and driver device is configured to receive an audio signal, modulate it and generate electric signals to operate the speaker and generate an acoustic audio signal.

### TECHNICAL FIELD

The present disclosure generally relates to systems and methods for generating an audio signal in a wearable device using a volume velocity transducer. In some examples the system and methods of generating an audio signal are applied in earphones, hearables, or hearing aids.

### BACKGROUND

U.S. Pat. No. 8,861,752 describes a picospeaker which is a novel sound generating device and a method for sound generation. The picospeaker creates an audio signal by generating an ultrasound acoustic beam which is then actively modulated. The resulting modulated ultrasound signal has a lower acoustic frequency sideband which corresponds to the frequency difference between the frequency of the ultrasound acoustic beam and the modulation frequency. US20160360320 and US20160360321 describe MEMS architectures for realizing the picospeaker. US20160277838 describes one method of implementation of the picospeaker using MEMS processing. US2016277845 describes an alternative method of implementation of the picospeaker using MEMS processing. A unique aspect of the picospeaker is that it constitutes a volume velocity driver or a pump speaker, hence it generates a constant air volume velocity regardless of frequency. This unique class of speakers provides impedance agnostic acoustic performance as well as small form factor and vibration free operation. However they require a new acoustic design to extract their unique performance. More ever, their small size and flexible acoustic output enable novel eartip configurations.

### Glossary

“acoustic signal”—as used in the current disclosure means a mechanical wave traversing either a gas, liquid or solid medium with any frequency or spectrum portion between 10 Hz and 10,000,000 Hz.
“audio” or “audio spectrum” or “audio signal”—as used in the current disclosure means an acoustic signal or portion of an acoustic signal with a frequency or spectrum portion between 10 Hz and 20,000 Hz.
“speaker” or “pico speaker” or “micro speaker” or “nano speaker” or “pump speaker”—as used in the current disclosure means a device configured to generate an acoustic signal with at least a portion of the signal in the audio spectrum.
“membrane”—as used in the current disclosure means a flexible structure constrained by at least one point.
“acoustic channel” or “acoustic port” or “time varying acoustic channel”—as used in the current disclosure means an acoustic element with an impedance defined by the mechanical dimensions and material constituents of the acoustic element. The mechanical dimensions change over time due to deformations or movement of the structures defining the acoustic channel.
“blind”—as used in the current disclosure means a structure with at least one acoustic channel or acoustic port through which an acoustic wave traverses with low loss.
“shutter”—as used in the current disclosure means a structure configured to move in reference to the blind and increase the acoustic loss of the acoustic path or ports. The combination of blind and shutter is one example of an acoustic channel or an alternative acoustic channel where the edge of one or more membranes defines an acoustic channel and deformations in the membrane change the edge location and acoustic impedance of the acoustic channel.
“acoustic medium”—as used in the current disclosure means any of but not limited to; a bounded region in which a material is contained in an enclosed acoustic cavity; an unbounded region where in which a material is characterized by a speed of sound and unbounded in at least one dimension. Examples of acoustic medium include but are not limited to; air; water; ear canal; closed volume around ear; air in free space; air in tube or another acoustic channel.
“active demodulation” or “demodulation”—as used in the current disclosure means any of but not limited to frequency shift of an ultrasound acoustic signal by modulation of the acoustic impedance of at least one part of the MEMS speaker.
“volume velocity driver” or “volume velocity transducer” or “pump speaker”—as used in the current disclosure means an audio transducer using modulated ultrasound to generate a volume velocity flow.

### SUMMARY

Some embodiments of the present disclosure may generally relate to a speaker device that includes at least one membrane and shutter. The membrane is positioned in a first plane and configured to oscillate along a first directional path and at a first frequency effective to generate an ultrasonic acoustic signal. The shutter is configured to modulate the ultrasonic acoustic signal such that an audio signal is generated. The speaker device is connected to a driver device where the driver device supplies at least two electrical signals to operate the speaker device at least one membrane and shutter respectively. The driver device receives an input audio signal from which it generates an ultrasound modulated audio signal to operate the membrane and generate an ultrasonic modulated signal. The driver further operates the shutter at the modulation frequency to demodulate the ultrasonic modulated signal and generate an acoustic audio signal.

Other embodiments of the present disclosure may generally relate to a speaker device comprising an array of membranes and shutters. The array of membranes and shutters operate either independently or driven by together by the driver device. In one example, the driving device is a semiconductor integrated circuit which includes; a controller; a charge pump configured to generate a high voltage signal; a switching unit configured to modulate the high voltage signal. The driving device receives a digital sound data stream and an operating voltage and outputs driving signals for the membrane, and shutter. In some embodiments the membrane and shutter operate asynchronously and or independently of each other at one or more frequencies. In further embodiments of the present disclosure the speaker device is embedded in an ear-tip with at least one acoustic port and the ear tip is configured to be inserted into the ear canal. In further embodiments the acoustic port includes an acoustic tube configured to provide an audio resonance. In further embodiments the ear tip further includes a second acoustic port connected to the speaker device backside and providing either a back cavity or external port. In alternative embodiments the ear tip is configured to accommodate a speaker device and a microphone where the speaker device and microphone share a common acoustic port configured to be in the ear canal. In further embodiments the ear tip can include further sensors or electrodes and sensors to provide additional sensing modalities.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are therefore not to be considered limiting of its scope, the disclosure will be described with additional specificity and detail through use of the accompanying drawings.

FIG. 1 is an example of a lumped element model of an earphone configured to accommodate a volume velocity driver.

FIG. 2 is an example of an ear-tip configured to accommodate a volume velocity driver and to fit into the ear canal.

FIG. 2A is a top view of FIG. 2.

FIG. 2B is cross section of taken along the line 2B-2B in FIG. 2A.

FIG. 2C is a side view of FIG. 2.

FIG. 2D is cross section of taken along the line 2D-2D in FIG. 2C.

FIG. 2E is a view from the rear of the ear-tip.

FIG. 2F is a view from the front of the ear tip which enters the ear canal.

FIG. 3A is an example of a top view of an ear-tip configured to accommodate a volume velocity driver and a microphone.

FIG. 3B is a cross section taken along the line 3B-3B of FIG. 3A.

FIG. 3C is a side view of an ear-tip configured to accommodate a volume velocity driver and a microphone.

FIG. 3D is cross section of taken along the line 3D-3D in FIG. 3C.

FIG. 4A is an alternative example of a top view of an ear-tip configured to accommodate a volume velocity driver.

FIG. 4B is cross section of taken along the line 4B-4B in FIG. 4A.

FIG. 5A is an example of a side view of an ear-tip configured to accommodate a volume velocity driver and a microphone.

FIG. 5B is cross section of taken along the line 5B-5B in FIG. 5A.

FIG. 6A is a further example of an exploded view of a driver enclosure and volume velocity driver.

FIG. 6B is top view of the driver enclosure and volume velocity driver of FIG. 6A.

FIG. 6C is cross section of taken along the line 60-6C in FIG. 6B.

FIG. 6D is a partially assembled view of view of the driver enclosure and volume velocity driver of FIG. 6A.

FIG. 7 is an example of a TWS earphone design using the ear-tip.

### DETAILED DESCRIPTION OF EXEMPLARY EMBODIMENTS

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other examples may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and make part of this disclosure. This disclosure is drawn, inter alia, to methods, apparatus, computer programs, and systems of generating an audio signal.

In some examples, a speaker device is described that includes a membrane and a shutter. The membrane is configured to oscillate along a first directional path and at a combination of frequencies with at least one frequency effective to generate an ultrasonic acoustic signal. A shutter and blind are positioned proximate to the membrane. In one non limiting example the membrane, the blind, and the shutter may be positioned in a substantially parallel orientation with respect to each other. In other examples the membrane, the blind, and the shutter may be positioned in the same plane and the acoustic signal is transmitted along acoustic channels leading from the membrane to the shutter. In a further example the modulator and or shutter are composed of more than one section.

In some embodiments, the membrane is driven by an electric signal that oscillates at a frequency Ω and hence moves at b Cos(λπ*Ωt), where b is the amplitude of the membrane movement, and t is time. The electric signal is further modulated by a portion that is derived from an audio signal a(t). The acoustic signal generated by the membrane is characterized as:

$$s ( t ) = b a ( t ) Cos ( 2 π * Ω t ) \qquad ( 1 )$$

Applying a Fourier transform to Equation (1) results in a frequency domain representation

$$S ( f ) = b / 2 * [ A ( f - Ω ) + A ( f + Ω ) ] \qquad ( 2 )$$

Where A(f) is the spectrum of the audio signal. Equation (2) describes a modulated audio signal with an upper and lower side band around a carrier frequency of Ω (Double Side Band—DSB). Applying to the acoustic signal of Equation (1) an acoustic modulator operating at frequency Ω results in

$$S ( t ) = b a ( t ) Cos ( 2 π * Ω t ) ( 1 + m Cos ( 2 π * Ω t ) ) \qquad ( 3 )$$

Where l is the loss of the modulator and m is the modulation function and due to energy conservation l+m<1. In the frequency domain

$${S}^{′} ( f ) = b / 4 * [ m A ( f ) + m A ( f + 2 Ω ) + A ( f - Ω ) + A ( f + Ω ) ] \qquad ( 4 )$$

Where b/4*m A(f) is an audio signal. The remaining terms are ultrasound signals where m A(f+2Ω) is at twice the modulation frequency and A(f−Ω)+A(f+Ω) is the original unmodulated signal. Additional acoustic signals may be present due to any but not limited to the following; ultrasound signal from the shutter movement; intermodulation signals due to nonlinearities of the acoustic medium; intermodulation signals due to other sources of nonlinearities including electronic and mechanical.

In one example we use the term “active demodulation” to describe the above functions where a frequency shift of an ultrasound acoustic signal is facilitated by modulation of the acoustic impedance of at least one part of the MEMS speaker.

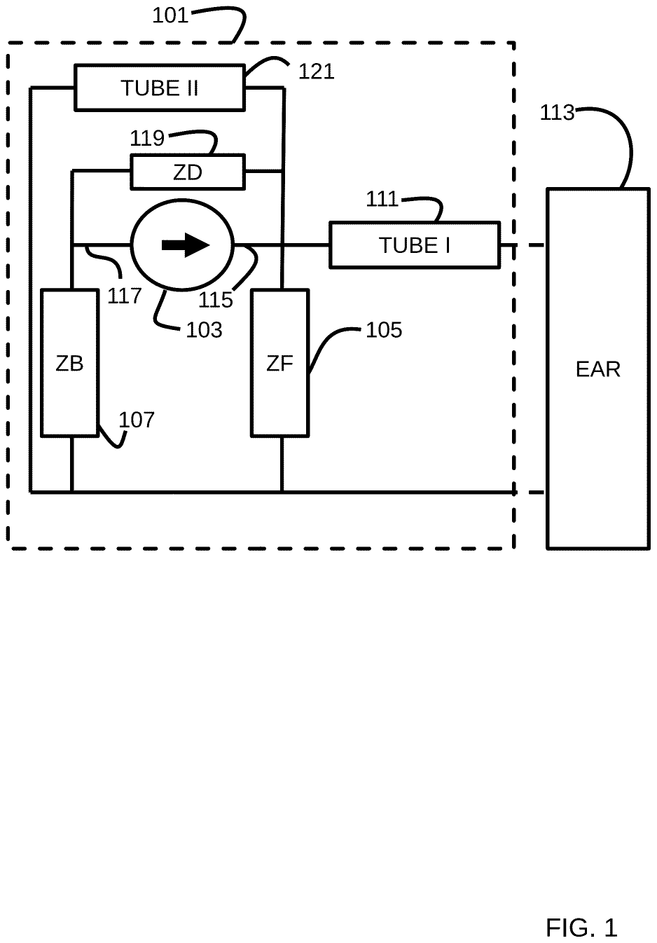

FIG. 1 is an example of a lumped element model of an earphone (101) configured to accommodate a volume velocity driver. A unique and novel aspect of the earphone design is the use of a current source (103) to represent the volume velocity driver. This is in contrast to state of art speakers which are represented as voltage sources combined with passive elements such as inductors, resistors and capacitors. The current source (103) provides current (or airflow in the acoustic description) regardless of impedance. This is the key characteristic of the volume velocity driver which provides freedom in acoustic design since the volume velocity is agnostic to the impedance. The earphone further includes a front volume represented by a lumped element impedance ZF (105), a back volume represented by a lumped element ZB (107) and an acoustic tube represented by TUBE I (111). The earphone (101) is in acoustic communication with an ear canal, represented in the lumped element model by a lumped element representation of an EAR (113). Three design consideration dictate choice of parameters. A front volume acts as a low pass filter reducing the sound pressure level of high frequencies. For practical and mechanical considerations, it may be required. The cut off frequency is a function of the acoustic tube impedance. Examples of cut off frequency include but are not limited to 5 KHz, 5-10 KHz, higher than 10 KHz, higher than 12 KHz, higher than 15 KHz, higher than 20 KHz. Examples of front volume include but are not limited to smaller than 0.5 cm³, or smaller than 0.1 cm³, or smaller than 0.05 cm³. The back volume may include leakage ports which provide an acoustic communication of the earphone with the surroundings. In a further example the back volume is configured as a tube. In a further example the back volume is configured as a volume and tube where the tube is either open, providing a leakage port or closed. In a further example, the back volume is configured with an open tube providing a frequency dependent acoustic path between the surroundings and the ear. In a further example the frequency dependent acoustic path is configured to attenuate specific frequencies for ambient noise reduction. In a further example the back volume includes orifices, conduits, channels or holes, or mesh structures providing acoustic loss represented as a lumped element resistor and or inductor. The volume velocity driver has an intrinsic channel connecting front size to back side and represented in the lumped element model by a resistor in parallel to the current source, ZD (119). It should be noted that the choice of ZB (107), ZD (119), TUBE I (111), and ZF (105) provides the freedom to design an tailored acoustic frequency response for the earphone (101). An acoustic tube represents a fundamental element in acoustics, functioning as a waveguide for sound propagation. Its behavior can be modeled using transmission line theory, accounting for viscous and thermal losses at the tube walls. For frequencies between 2-20,000 Hz, these losses significantly affect both the wave propagation and the characteristic impedance of the tube. The complete model considers both uniform tubes and those with varying cross-sections, with the transfer function describing the relationship between input and output acoustic pressures. For a uniform tube with length L and radius R, the transfer function H(s) is given by:

$$H ( s ) = cosh ( G L ) + {Z}_{C} sinh ( GL ) / Z o \qquad ( 5 )$$

Where the propagation constant G (Gamma) includes both attenuation and phase terms:

$$G = a + jb \qquad ( 6 )$$

The attenuation constant a (alpha) and wave number b (beta) are:

$$a = ( w / c ) ( r v / 2 + ( y - 1 ) r t / 2 ) \qquad ( 7 )$$

$$b = ( w / c ) [ 1 - ( rv / 2 + ( y - 1 ) r t / 2 ) \hat{} 2 ] \hat{} ( 1 / 2 )$$

The viscous and thermal coefficients are:

$$rv = ( 2 u / poc ) \hat{} ( 1 / 2 ) ( w / c ) \hat{} ( - 1 / 2 ) / R \qquad ( 8 )$$

$$rt = ( 2 k / pocCp ) \hat{} ( 1 / 2 ) ( w / c ) \hat{} ( - 1 / 2 ) / R$$

The characteristic impedance with losses is:

$$Zc = ( p o c / S ) [ 1 + ( 1 - j ) ( rv / 2 + ( y - 1 ) r t / 2 ) ] \qquad ( 9 )$$

Where: u=viscosity coefficient, k=thermal conductivity, y=specific heat ratio, po=air density, Cp=specific heat at constant pressure, S=cross-sectional area, c=speed of sound, w=angular frequency. For an open-ended tube, the load impedance ZL is approximated by:

$$Z L \approx p oc ( k \hat{} 2 R \hat{} 2 / 4 + jkdl ) \qquad ( 10 )$$

Where dl is the end correction length, approximately 0.61R. For tubes with varying cross-section, the local transfer function becomes:

$$H ( s , x ) = P ( x ) / P ( 0 ) = exp ( - G x ) \qquad ( 11 )$$

The input impedance, considering both the characteristic impedance and load conditions, is:

$$Zin = Z c [ Z L + Zc tanh ( GL ) ] / [ Z c + ZL tanh ( G L ) ] \qquad ( 12 )$$

The TUBE I (111) provides a frequency dependent acoustic path from the volume velocity driver (103) to the ear (113). In one example the acoustic path is configured to have at least a first resonance at an of but not limited to, 2 KHz, 3 KHz, 4 KHz, 5 KHz, any frequency between 2-8 KHz. In a further example the tube includes an acoustic mesh configured to reduce the resonant Q factor and expand the frequency width of the resonance. In an alternative example the tube is configured to include acoustic loss by either material choice or tube width design to promote thermal and viscous acoustic losses. Examples of tube diameters include but are not limited to 0.2 mm; 0.5 mm; 1.0 mm; greater than 2 mm; between 0.5 and 3.0 mm. Example of tube materials include but are not limited to polymers including but not limited to Silicone; plastics; PETG; Nylon; metals including but not limited to Aluminum; Copper; Nickel; Brass and combinations of metals and or polymers. In a further example TUBE I (111) is extended with a second acoustic tube TUBE II (121) connecting volume velocity driver (103) to surrounding.

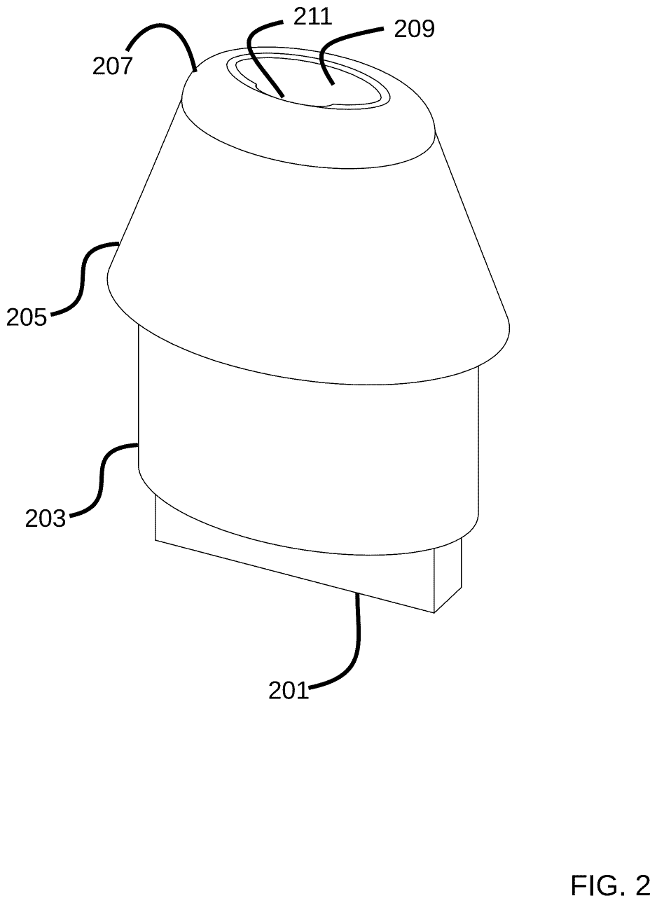

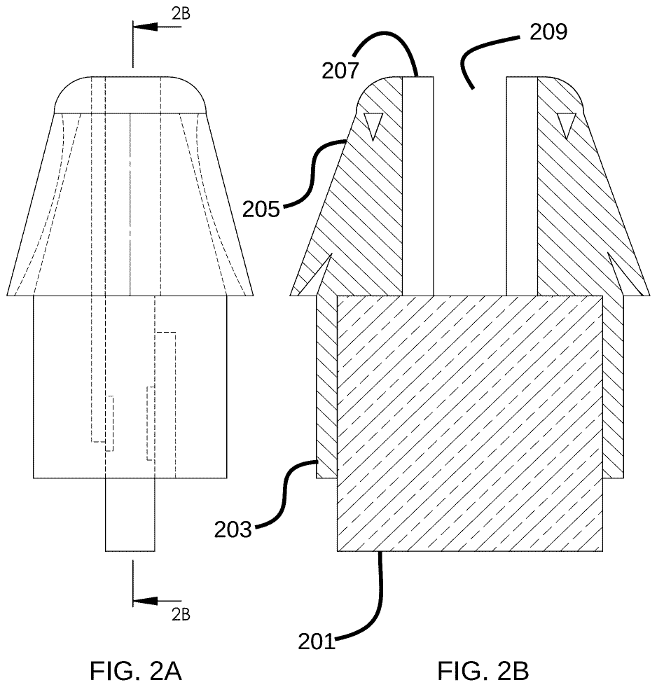

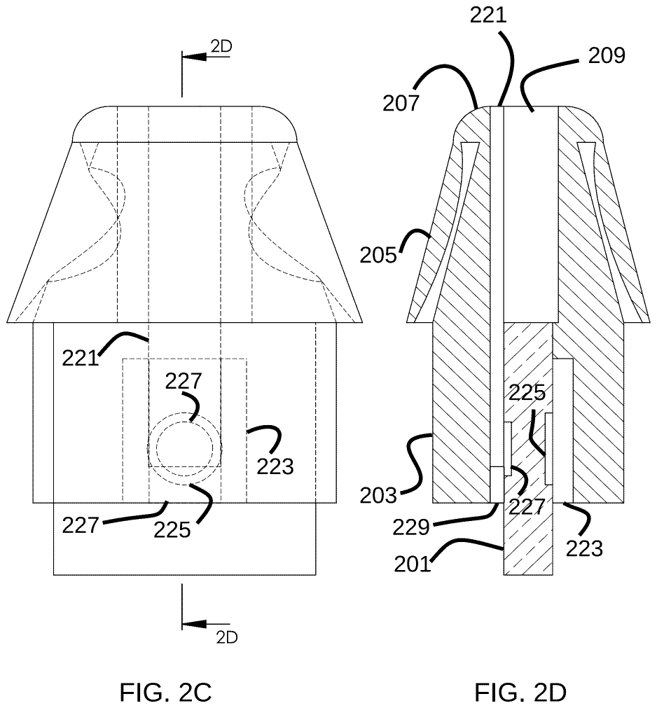

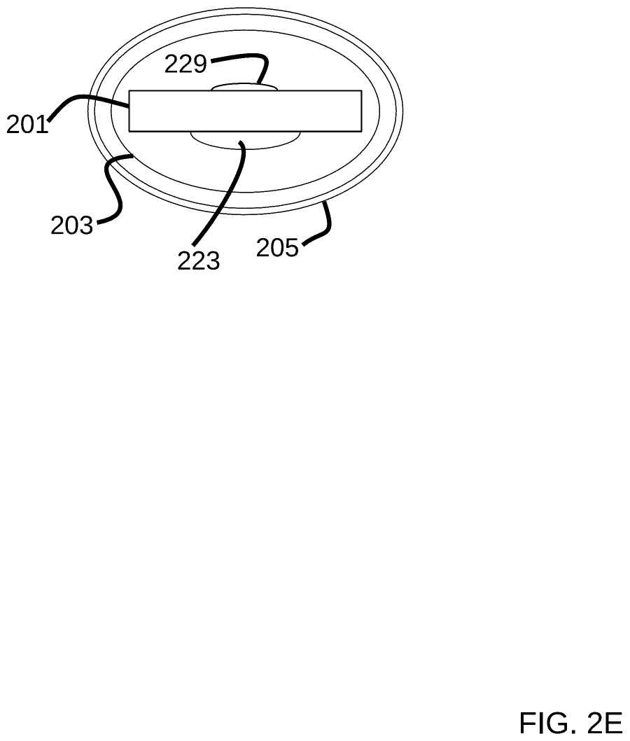

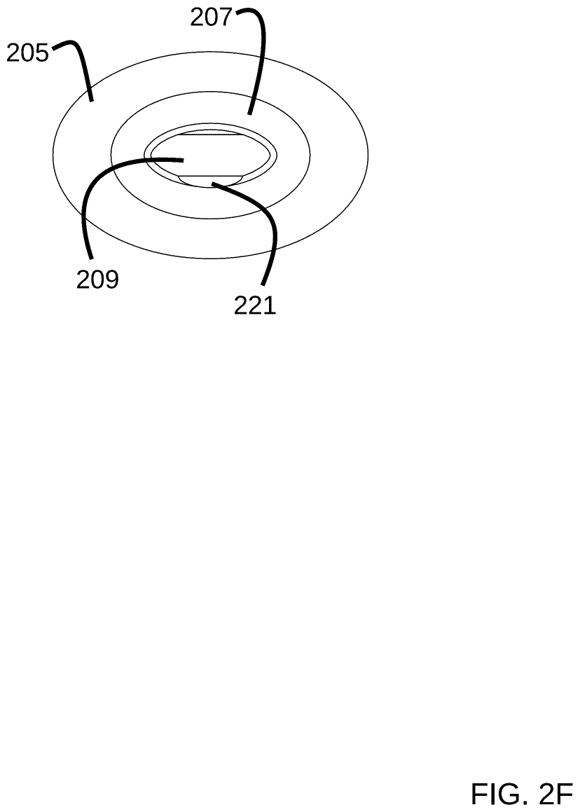

FIGS. 2 to 2F is an example of an ear-tip configured to accommodate a volume velocity driver (201) and to fit into the ear canal. The ear-tip includes but is not limited to driver enclosure (203) configured to mechanical connect to the volume velocity driver (201) and to provide the acoustic elements defined in FIG. 1. The ear-tip further includes a crown (205) configured to provide a mechanical fixture in the ear canal. In a further example the crown is configured to provide either an occluded fit in the ear canal limiting all acoustic communication to channels defined in the driver enclosure (203). In an alternative example the crown (205) is configured with holes providing a non-occluded fit into the ear canal and an additional leakage path from the ear canal to the surroundings. The crown (205) is connected to the driver enclosure with a crown ring (207). The crown ring (207) provides an aperture for an acoustic tube (FIG. 2C 221) contained in the driver enclosure (203). In a further example the crown ring includes a recess (209) providing an acoustic front volume. FIGS. 2A, 2B is a top view and cross section of FIG. 2 highlighting the volume velocity driver (201), driver enclosure (203), crown (205), crown ring (207) and recess (209). FIGS. 2C, 2D is a side view and cross section of FIG. 2 further highlighting a first acoustic port (225) and second acoustic port (227) of the volume velocity driver. First and second acoustic port (225, 227) are represented by first and second electrical connections (FIG. 1, 115, 117) of current source (FIG. 1, 103). First acoustic port (225) is connected to acoustic tube (221). Acoustic tube (221) is configured as a open tube towards the ear canal, and a closed acoustic tube towards the surrounding. In a further example acoustic tube (221) is extended by at least a second acoustic tube (229) and corresponding to lumped element TUBE II (FIG. 1, 121) providing an open connection to the surroundings. In a further example, driver enclosure (203) is configured to include a back volume (223) corresponding to ZB (FIG. 1, 107). In one example (not depicted in FIG. 2), back volume (225) is a closed volume and is represented in the lumped element model as a capacitor. In an alternative example depicted in FIGS. 2C,2D the back volume is in communication with the surroundings. In a further example a back volume includes apertures, holes or a mesh element to create a resistive and or inductive element in the lumped element representation. FIG. 2E is a view from the rear of the ear-tip depicting the volume velocity driver (201), back cavity (223), second acoustic tube (229), driver enclosure (203) and crown (205). FIG. 2F is a view from the front of the ear tip which enters the ear canal depicting the front tube (221), front cavity (209), crown ring (207) and crown (205). The electrical connection of the volume velocity driver (201) to the driver ASIC is facilitated by either electrical wires, flexible PCB rigid PCB or rigid and flex PCB. The driver enclosure (203) is further configured to enclose the electrical wires, flex, rigid or combined PCB. In a further example the driver enclosure (203) is made from a flexible material. In an alternative further example, the driver enclosure (203) is made from a rigid material and the crown ring (207) is configured to connect the flexible crown to the rigid driver enclosure (203). In an alternative further example, the driver enclosure (203) is made from two or more materials where at least one material is flexible and a second material is rigid. The flexible material is configured to provide an acoustic seal between the driver enclosure (203) and the volume velocity driver (201) to prevent undesired acoustic leakage. In an alternative further example, the driver enclosure (203) is made from a rigid material, and an adhesive is used to connect the volume velocity driver (201) to the driver enclosure (203) and prevent unwanted acoustic leakage. In an alternative example the driver enclosure (203) is made also from any of but not limited to thermoplastic material; shape memory alloy; shrink wrap material; thermally shaped material where the application of heat can change the shape and or texture of the driver enclosure to create a mechanical and acoustical connection to the volume velocity driver.

In a further example, the ear-tip integrates additional sensors within its structure. The crown (205) includes electrodes embedded in its surface for measuring ear canal electrode impedance between 100 Hz to 10 kHz, enabling enhanced fit detection and electrode contact verification. The driver enclosure (203) accommodates a temperature sensor positioned near the acoustic tube (221) for monitoring ear canal temperature. In a further example, PPG (Photoplethysmography) sensors integrate into the crown surface (205), utilizing dual wavelengths (green 520 nm and red 660 nm) directed toward the ear canal wall through optical waveguides molded into the crown material. In another example, Electromyography (EMG) sensing electrodes are embedded in specific locations around the crown (205) where it contacts the ear canal wall. The EMG electrodes, fabricated from biocompatible conductive silicone, detect electrical signals from the auricular muscles in the 50 Hz to 150 Hz frequency band. A differential electrode configuration, utilizing at least three contact points spaced at 120° intervals around the crown circumference, enables spatial isolation of muscle activation patterns. This configuration enables detection of jaw movement, facial expressions, and ear canal deformations that can be mapped to user control inputs or biometric monitoring functions while maintaining the acoustic seal of the ear-tip. The sensor-enabled ear-tip supports a range of applications across healthcare, fitness, and human interface domains. It can monitor heart rhythm, track core body temperature, and assess sleep quality using data from motion, temperature, and biometric inputs. The system detects specific patterns, such as bruxism, through muscle activity and supports athletic use cases like heat stress prevention, oxygen saturation tracking, and heart rate variability analysis. Additionally, it enables hands-free device control using facial muscle and jaw movements, recognizes head gestures for interface control, and adjusts audio settings based on activity or social interactions. Contextual features include automatic volume control during exercise, social interaction detection, and intelligent notification management based on user state. These capabilities are powered by integrated sensor processing and adaptable system management.

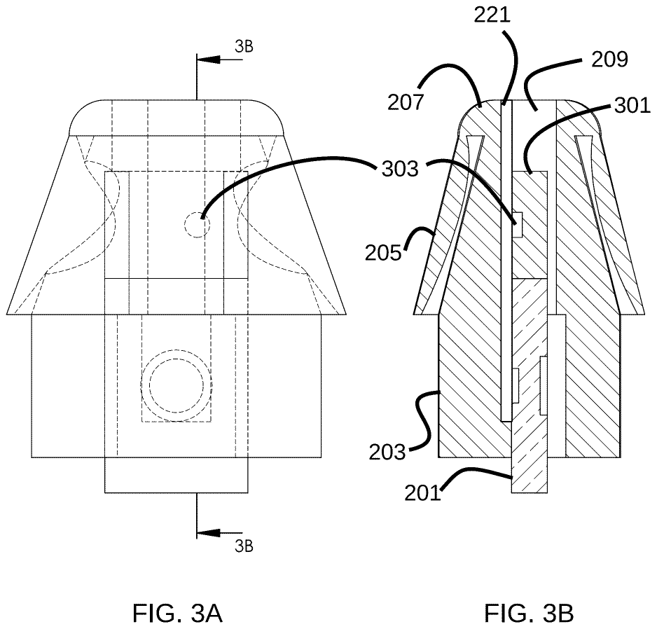

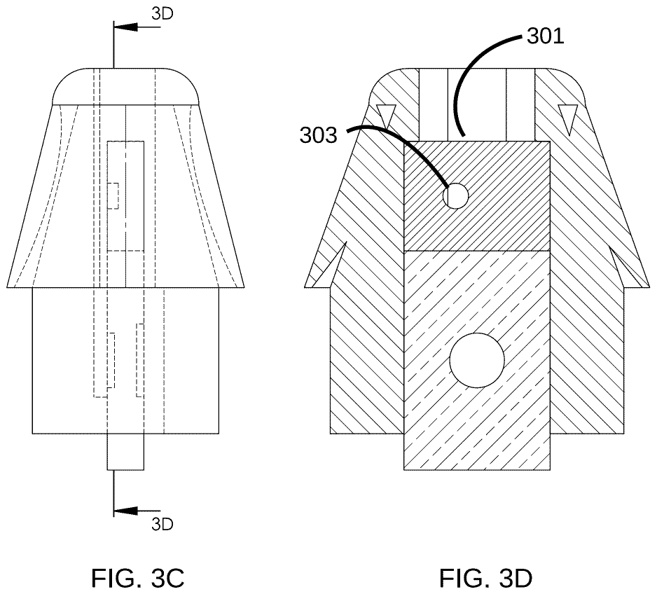

FIGS. 3A, 3B is an example of a top view and cross section of an ear-tip configured to accommodate a volume velocity driver (201) and a microphone (301). In a further example microphone (301) acoustic aperture (303) is configured to connect to acoustic tube (221). Examples of microphone include but are not limited to MEMS microphones, top port MEMS microphones and bottom port MEMS microphones. FIGS. 3C, 3D is an example of a side view and cross section of an ear-tip configured to accommodate a volume velocity driver and a microphone. The electrical connection of the volume velocity driver (201) to the driver ASIC and of the microphone (301) to the electronics of the earphone is facilitated by either electrical wires, flexible PCB rigid PCB or rigid and flex PCB. The driver enclosure (203) is further configured to enclose the electrical wires, flex, rigid or combined PCB. In an alternative example the volume velocity driver (201) includes a microphone with a suitable acoustic aperture and electrical connection. Further examples include additional or alternative sensors including but not limited to; electrical sensors for EMG detection; optical sources and sensors for PPG or temperature sensing; accelerometers or vibration sensing microphone. In an alternative example a microphone (301) is located on one side of the volume velocity driver (201) and connected to acoustic tube (221). In a further example either volume velocity driver (201) and or microphone (301) is configured to transmit and receive ultrasound acoustic signals. A volume velocity driver (201) transmits ultrasonic acoustic signals at frequencies any of but not limited to up to 20 KHz; up to 50 KHz; up to 100 KHz; up to 1 MHz; up to 10 MHz. A microphone (301) is configured to receive ultrasound acoustic signals at frequencies up to 100 KHz. In a further example at higher frequencies either membranes on microphone (301) or designated membranes on volume velocity driver (201) are configured as a resonant detectors of ultrasound acoustic signals transmitted by volume velocity driver (201).

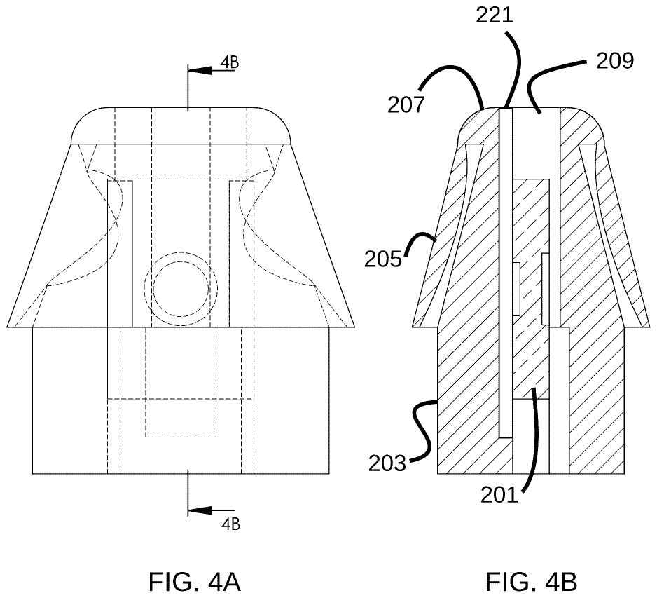

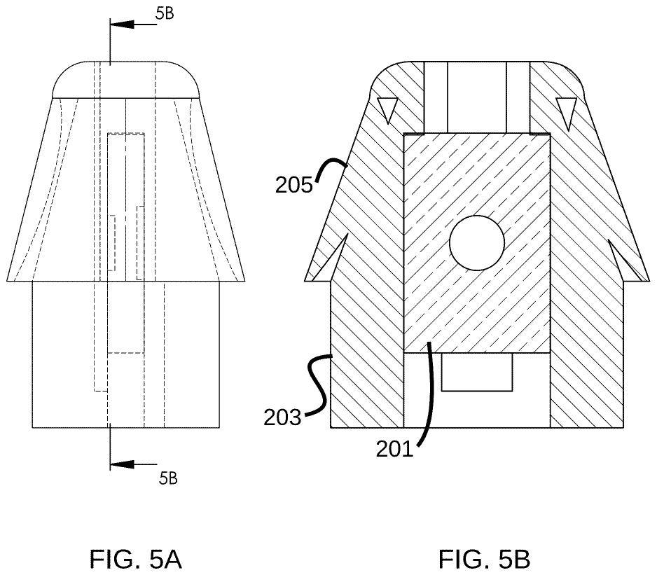

FIGS. 4A, 4B is an alternative example of a top view and cross section of an ear-tip configured to accommodate a volume velocity driver (201). In one example the volume velocity driver (201) is configured to be inserted into the ear canal so the overlap between crown (205) and driver is larger (201) than in previous examples. In a further example the driver width is any of but not limited to; smaller than 5 mm, smaller than 4 mm, smaller than 3 mm. In a further example the volume velocity driver (201) height is any of but not limited to less than 2 mm, less than 1.5 mm, less than 1 mm. FIGS. 5A, 5B is an example of a side view and cross section of an ear-tip configured to accommodate a volume velocity driver and a microphone. In one example the volume velocity driver (201) is configured to be inserted into the ear canal so the overlap between crown (205) and driver is larger (201) than in previous examples.

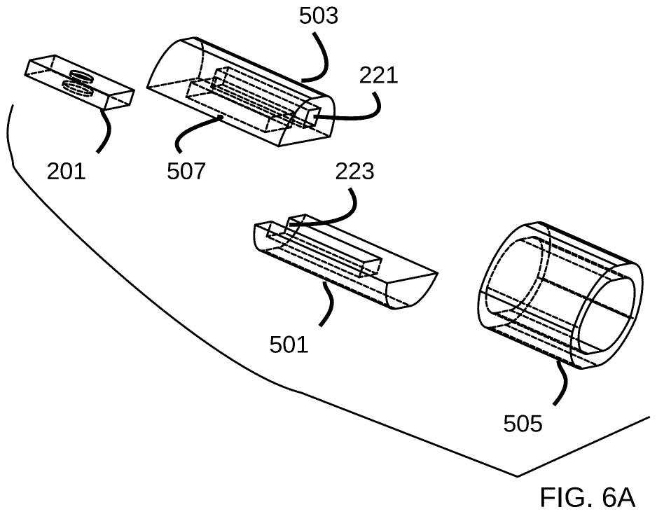

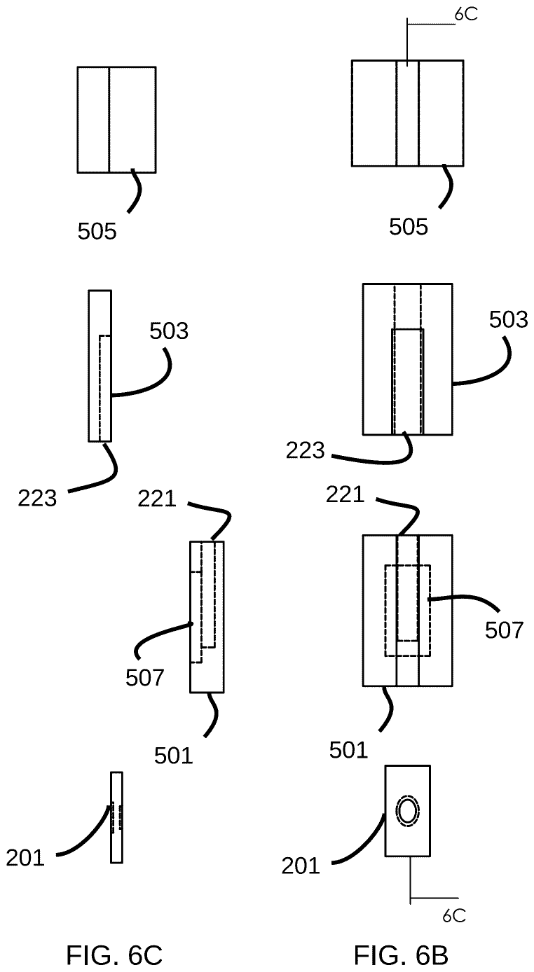

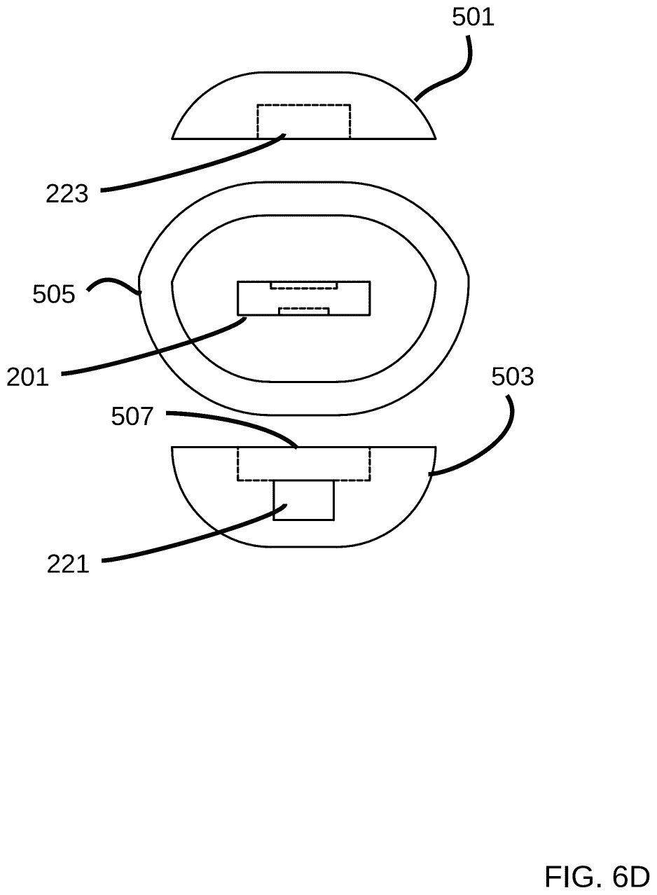

FIGS. 6A-6D is an alternative example of a driver enclosure (FIG. 2, 203) and volume velocity driver (201) where the driver enclosure includes at least but not limited to a first cap (501) configured for acoustic and mechanical contact to at least a portion of a first side of volume velocity driver (201) and a second cap (503) configured for acoustic and mechanical contact to at least a portion of a second side of volume velocity driver. Mechanical attachment methods include but are not limited to adhesion using a bonding material or adhesive material, soldering, brazing, welding, ultrasonic welding, eutectic bonding, reflow soldering, thermoplastic material. In an alternative example, first cap (501) and second cap (503) attach to volume velocity drive (201) due to mechanical force applied externally by a support structure (505). The support structure (505) is configured to apply a force to keep first and second cap (501, 503) secured against volume velocity driver. Support structure can be configured as any of but not limited to a rigid structure; a flexible structure; a shape changing structure. Support structure can be manufactured from any of but not limited to metals including but not limited to Aluminum, Copper, Brass, Nickel, Stainless Steel, or combinations of these; plastics, ceramic, thermoplastic material, shrinkable materials, shape change alloys, thermosetting material or combinations of these. In a further example a cap (501, 503) includes a recess (507) configured to contain a portion of the volume velocity driver and ensure its position in relation to the cap (501, 503). In a further example caps (501, 503) include acoustic channels (221, 223) connected to volume velocity acoustic ports.

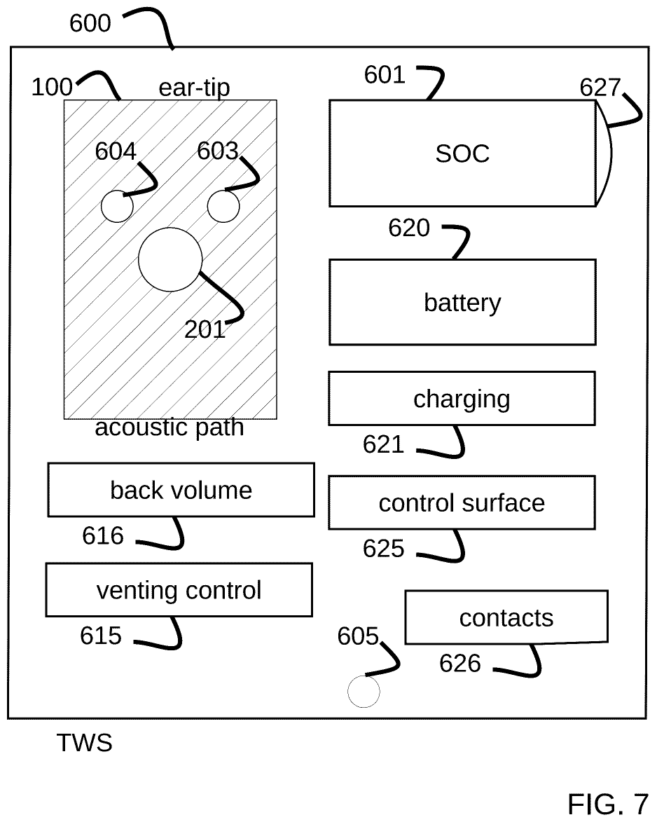

FIG. 7 is an example of a TWS earphone (600) design using the ear-tip (FIG. 1, 100). In one example, the volume velocity driver ear-tip integrates into a True Wireless Stereo (TWS) system (600). The TWS system includes a System on Chip (SoC) (601) that provides core audio and wireless functionality through an integrated digital signal processor, Bluetooth 5.3 controller, and audio codec with amplifiers. The SoC (601) connects to multiple MEMS microphones positioned for comprehensive acoustic sensing: a feed-forward microphone (603) configured to sense the external surroundings and a feedback microphone (604) configured to sense the speaker output and ear canal. In one example the feedback microphone is located near the volume velocity driver (201) and in the ear-tip (100). In a further example the TWS earphone further includes a voice pickup microphone (605) located on the TWS housing body. This microphone array enables active noise cancellation and voice communication. In another example, the acoustic implementation includes the volume velocity driver (201) integrated into the ear-tip assembly (100), with acoustic waveguides and meshes for optimal sound delivery. In a further example a sealed back volume (615) in the TWS housing provides acoustic support, while a venting system (616) maintains proper pressure equalization. The system's DSP executes real-time processing of the microphone signals, with algorithms optimized for the volume velocity driver characteristics, including adaptive feedback noise suppression, 3D sound adaptation and personalized audio equalization. In a further example, power management and physical integration utilizes a lithium-ion battery (620) with charging circuitry (621), contained within the TWS body. In a further example the housing integrates touch-sensitive control surfaces (625), charging contacts (626), and an antenna design (627) for Bluetooth connectivity. In a further example the component arrangement minimizes electromagnetic interference while maintaining acoustic performance.

To sum, we describe an earphone system which includes a volume velocity driver comprised of one or more membranes generating an ultrasonic acoustic signal, a shutter configured to modulate the ultrasonic acoustic signal to generate an audio signal, and a driver device operatively coupled to the volume velocity driver. The driver device is configured to supply electrical signals to the volume velocity driver and generate an audio signal. The driver device is further configured to receive an input audio signal and generate an ultrasound modulated audio signal to generate an acoustic ultrasonic signal and a signal driving the modulator to modulate the acoustic ultrasound signal and generate an audio signal corresponding to a volume velocity driver or pump speaker. In a further example the volume velocity driver is used in an ear-tip with at least one acoustic port is configured to be inserted into an ear canal, where the at least one acoustic port includes an acoustic tube configured to provide an audio resonance. The ear-tip may further include a second acoustic port connected to a backside of the volume velocity driver. An ear-tip for an earphone includes a volume velocity driver with at least a first acoustic aperture, a microphone positioned adjacent to the volume velocity driver, and an acoustic tube connected to the first acoustic aperture and configured to be in contact with an ear canal. The microphone may be a MEMS microphone positioned on one side of the volume velocity driver. The ear-tip may further include a plurality of sensors integrated into it, such as electrodes, a temperature sensor, PPG sensors, or EMG sensors. A TWS earphone includes an ear-tip assembly with a volume velocity driver, a system on chip (SoC) operatively coupled to the volume velocity driver, a plurality of MEMS microphones operatively coupled to the SoC, and a sealed back volume configured to provide acoustic support to the volume velocity driver. The plurality of MEMS microphones may include a feed-forward microphone and a feedback microphone. A digital signal processor (DSP) executes real-time processing of signals from the MEMS microphones. The TWS earphone may further include a venting system for pressure equalization, a lithium-ion battery, and charging circuitry. The acoustic tube in the ear-tip is configured to have at least a first resonance between 2 kHz and 8 kHz and may include an acoustic mesh to reduce the resonant Q factor and expand the frequency width of the resonance. The driver enclosure of the ear-tip can be made from a flexible material or a rigid material with the crown ring connecting a flexible crown to the rigid driver enclosure. In an alternative example an ear-tip for an earphone comprised of a volume velocity driver including at least a first acoustic aperture, a driver enclosure housing the volume velocity driver, a crown configured to provide a mechanical fixture in an ear canal, a crown ring connecting the driver enclosure to the crown, an acoustic tube within the driver enclosure, the acoustic tube connected to the first acoustic aperture of the volume velocity driver and configured to deliver sound to the ear canal. In a further example the volume velocity driver further includes a second aperture, and the driver enclosure further includes a back volume connected to the second aperture. In a further example the acoustic tube is configured to have at least a first resonance frequency between 2 kHz and 8 kHz. In a further example the acoustic tube includes an acoustic mesh configured to reduce a resonant Q factor and expand a frequency width of a resonance. In a further example the driver enclosure is made from a flexible material. In a further example the driver enclosure is made from a rigid material and the crown ring is configured to connect the crown to the rigid driver enclosure. IN a further example the crown is made from a flexible material. In a further example further comprising a plurality of sensors integrated into the ear-tip, the sensors including at least one of electrodes, a temperature sensor, PPG sensors, or EMG sensors. In an alternative example an ear-tip for an earphone comprised of a volume velocity driver including at least a first acoustic aperture, a microphone positioned adjacent to the volume velocity driver, a driver enclosure housing the volume velocity driver and the microphone, a crown configured to provide a mechanical fixture in an ear canal, a crown ring connecting the driver enclosure to the crown, and an acoustic tube within the driver enclosure, the acoustic tube connected to the first acoustic aperture of the volume velocity driver and configured to deliver sound to the ear canal. In a further example the microphone is a MEMS microphone. In a further example the microphone is positioned on one side of the volume velocity driver. In a further example the microphone shares the acoustic tube with the volume velocity driver. In an alternative example a TWS earphone comprising, an ear-tip assembly including: a volume velocity driver, a driver enclosure housing the volume velocity driver, a crown configured to provide a mechanical fixture in an ear canal, and a crown ring connecting the driver enclosure to the crown, a system on chip (SoC) operatively coupled to the volume velocity driver, plurality of MEMS microphones operatively coupled to the SoC, the plurality of MEMS microphones including a feed-forward microphone and a feedback microphone; and a sealed back volume configured to provide acoustic support to the volume velocity driver. In a further example the TWS earphone further comprised of a digital signal processor (DSP) configured to execute real-time processing of signals from the plurality of MEMS microphones. In a further example the TWS earphone further comprised of a venting system configured to maintain pressure equalization in the earphone. In a further example the TWS earphone further comprised of a lithium-ion battery and charging circuitry. In an alternative example a method of generating an audio signal in an ear-tip of an earphone, the method comprising, receiving an input audio signal at a driver device operatively coupled to a volume velocity driver housed within a driver enclosure of the ear-tip, generating an audio signal using the volume velocity driver based on the input audio signal, delivering the audio signal to an ear canal via an acoustic tube connected to an acoustic aperture of the volume velocity driver; and supplying electrical signals to the volume velocity driver using the driver device. In a further example the method is comprised of providing a mechanical fixture in the ear canal using a crown of the ear-tip. In a further example the method is comprised of reducing a resonant Q factor and expanding a frequency width of a resonance of the acoustic tube using an acoustic mesh within the acoustic tube. In a further example the volume velocity driver includes a second aperture, and the method further comprises providing a back volume connected to the second aperture. In a further example comprised of integrating a plurality of sensors into the ear-tip, the sensors including at least one of electrodes, a temperature sensor, PPG sensors, or EMG sensors.

There is little distinction left between hardware and software implementations of aspects of systems; the use of hardware or software is generally (but not always, in that in certain contexts the choice between hardware and software can become significant) a design choice representing cost versus efficiency tradeoffs. There are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to disclosures containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”. Speaker and picospeaker are interchangeable and can be used in in place of the other.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. An ear-tip for an earphone comprising:
a volume velocity driver including at least a first acoustic aperture;
a driver enclosure housing the volume velocity driver;
a crown configured to provide a mechanical fixture in an ear canal;
a crown ring connecting the driver enclosure to the crown; and
an acoustic tube within the driver enclosure, the acoustic tube connected to the first acoustic aperture of the volume velocity driver and configured to deliver sound to the ear canal.

2. The ear-tip of claim 1, wherein the volume velocity driver further includes a second aperture, and the driver enclosure further includes a back volume connected to the second aperture.

3. The ear-tip of claim 1, wherein the acoustic tube is configured to have at least a first resonance frequency between 2 kHz and 8 KHz.

4. The ear-tip of claim 1, wherein the acoustic tube includes an acoustic mesh configured to reduce a resonant Q factor and expand a frequency width of a resonance.

5. The ear-tip of claim 1, wherein the driver enclosure is made from a flexible material.

6. The ear-tip of claim 1, wherein the driver enclosure is made from a rigid material and the crown ring is configured to connect the crown to the rigid driver enclosure.

7. The ear-tip of claim 1, further comprising a plurality of sensors integrated into the ear-tip, the sensors including at least one of electrodes, a temperature sensor, PPG sensors, or EMG sensors.

8. An ear-tip for an earphone comprising:
a volume velocity driver including at least a first acoustic aperture;
a microphone positioned adjacent to the volume velocity driver;
a driver enclosure housing the volume velocity driver and the microphone;
a crown configured to provide a mechanical fixture in an ear canal;
a crown ring connecting the driver enclosure to the crown; and
an acoustic tube within the driver enclosure, the acoustic tube connected to the first acoustic aperture of the volume velocity driver and configured to deliver sound to the ear canal.

9. The ear-tip of claim 8, wherein the microphone is a MEMS microphone.

10. The ear-tip of claim 8, wherein the microphone is positioned on one side of the volume velocity driver.

11. The ear-tip of claim 8, wherein the microphone shares the acoustic tube with the volume velocity driver.

12. A TWS earphone comprising:
an ear-tip assembly including:
a volume velocity driver,
a driver enclosure housing the volume velocity driver,
a crown configured to provide a mechanical fixture in an ear canal, and
a crown ring connecting the driver enclosure to the crown;
a system on chip (SoC) operatively coupled to the volume velocity driver;
a plurality of MEMS microphones operatively coupled to the SoC, the plurality of MEMS microphones including a feed-forward microphone and a feedback microphone; and a sealed back volume configured to provide acoustic support to the volume velocity driver.

13. The TWS earphone of claim 12, further comprising a digital signal processor (DSP) configured to execute real-time processing of signals from the plurality of MEMS microphones.

14. The TWS earphone of claim 12, further comprising a venting system configured to maintain pressure equalization in the earphone.

15. The TWS earphone of claim 12, further comprising a lithium-ion battery and charging circuitry.

16. A method of generating an audio signal in an ear-tip of an earphone, the method comprising:
receiving an input audio signal at a driver device operatively coupled to a volume velocity driver housed within a driver enclosure of the ear-tip;
generating an audio signal using the volume velocity driver based on the input audio signal;
delivering the audio signal to an ear canal via an acoustic tube connected to an acoustic aperture of the volume velocity driver; and
supplying electrical signals to the volume velocity driver using the driver device.

17. The method of claim 16, further comprising providing a mechanical fixture in the ear canal using a crown of the ear-tip.

18. The method of claim 16, further comprising reducing a resonant Q factor and expanding a frequency width of a resonance of the acoustic tube using an acoustic mesh within the acoustic tube.

19. The method of claim 16, wherein the volume velocity driver includes a second aperture, and the method further comprises providing a back volume connected to the second aperture.

20. The method of claim 16, further comprising integrating a plurality of sensors into the ear-tip, the sensors including at least one of electrodes, a temperature sensor, PPG sensors, or EMG sensors.
